(19) United States
(12) Patent Application Publication
(10) Pub. No.: US 2026/0011116 A1
(43) Pub. Date: Jan. 8, 2026

(54) INFORMATION PROCESSING APPARATUS, INFORMATION PROCESSING METHOD, AND NON-TRANSITORY COMPUTER-READABLE STORAGE MEDIUM

(71) Applicant: CANON KABUSHIKI KAISHA, Tokyo (JP)

(72) Inventor: Takahiro DOZONO, Tokyo (JP)

(21) Appl. No.: 19/260,963

(22) Filed: Jul. 7, 2025

(30) Foreign Application Priority Data
Jul. 8, 2024 (JP) 2024-109751

(51) Int. Cl. G06V 10/70; G06V 10/25; G06V 20/70

(52) U.S. Cl. CPC G06V 10/70; G06V 10/25; G06V 20/70; G06V 2201/07

(57) ABSTRACT

An information processing apparatus comprises an acquisition unit configured to, for each of pre-trained models, acquire results of object detection from an image performed by the pre-trained model, a selection unit configured to, for each of the pre-trained models, select a result to be outputted out of the results of object detection from the image performed by the pre-trained model, and an output unit configured to output the result selected by the selection unit for each pre-trained model.

### BACKGROUND

### Field of the Technology

The present disclosure relates to an information processing technique.

### Description of the Related Art

In recent years, with the rapid progress of digital technology, the utilization of AI in various fields has attracted attention. In particular, in AI, there is supervised learning in which features in supervisor data are automatically extracted based on supervisor data containing ground truth data to thereby generate an inference model.

In order to obtain an AI trained model with high generalization performance in supervised learning, supervisor data, in which various types of images determined according to the task to be solved and annotation information corresponding to objects contained in the image make a set, are used. To do so, as preliminary preparation for execution of AI training, collection of images suitable for the training and annotation work of generating supervisor data by a person manually, or otherwise, adding annotation information is necessary. In doing this, a large amount of supervisor data is required to generate a machine learning model with high generalization performance, and therefore there is a problem in that a large amount of time is required for the annotation work performed manually. Studies have been conducted using a model that is pre-trained with the same type of images as an image to be annotated as a method of supporting manual annotation work.

For example, Japanese Patent Laid-Open No. 2022-105923 discloses a method of presenting annotation information that is to be a reference when a result of object detection in a pre-trained model is added as a ground truth. Japanese Patent Application No. 2021-504744 discloses a method in which results of object detection by a plurality of pre-trained models are scored, a result having a highest score is automatically selected, and annotation information of the selected result is superimposed on an image and presented.

However, in Japanese Patent Laid-Open No. 2022-105923 and Japanese Patent Application No. 2021-504744, since all detection results of a pre-trained model are presented to the user, there was a problem in that a result of erroneous detection by a pre-trained model may also be presented in the input image.

### SUMMARY

The present disclosure provides a technique for enabling more accurate output of object detection results.

According to the first aspect of the present disclosure, there is provided an information processing apparatus, comprising: an acquisition unit configured to, for each of pre-trained models, acquire results of object detection from an image performed by the pre-trained model; a selection unit configured to, for each of the pre-trained models, select a result to be outputted out of the results of object detection from the image performed by the pre-trained model; and an output unit configured to output the result selected by the selection unit for each pre-trained model.

According to the second aspect of the present disclosure, there is provided an information processing method performed by an information processing apparatus, the method comprising: for each of pre-trained models, acquiring results of object detection from an image performed by the pre-trained model; for each of the pre-trained models, selecting a result to be outputted out of the results of object detection from the image performed by the pre-trained model; and outputting the selected result for each pre-trained model.

According to the third aspect of the present disclosure, there is provided a non-transitory computer-readable storage medium storing a computer program for causing a computer to function as: an acquisition unit configured to, for each of pre-trained models, acquire results of object detection from an image performed by the pre-trained model; a selection unit configured to, for each of the pre-trained models, select a result to be outputted out of the results of object detection from the image performed by the pre-trained model; and an output unit configured to output the result selected by the selection unit for each pre-trained model.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1A is a block diagram illustrating an example of a hardware configuration of an information processing apparatus.

FIG. 1B is a block diagram illustrating an example of a hardware configuration of the information processing apparatus.

FIG. 2 is a block diagram illustrating an example of a functional configuration of the information processing apparatus.

FIG. 3A is a view illustrating an example of display of object detection results.

FIG. 3B is a view illustrating an example of display of object detection results.

FIG. 4 is a view illustrating a display example of a screen for correction.

FIG. 5A is a flowchart of an operation of the information processing apparatus.

FIG. 5B is a flowchart of an operation of the information processing apparatus.

FIG. 6 is a view illustrating an example of a configuration of annotation information.

FIG. 7A is a view illustrating an example of a configuration of a pre-trained model group.

FIG. 7B is a view illustrating an example of a configuration of a pre-trained model group.

FIG. 7C is a view illustrating an example of display of object detection results.

FIG. 8A is a flowchart of an operation of the information processing apparatus.

FIG. 8B is a flowchart of an operation of the information processing apparatus.

FIG. 9A is a view illustrating an example of processing up until a result of a pre-trained model that is selected most often is adopted.

FIG. 9B is a view illustrating an example of processing up until a result of a pre-trained model that is selected most often is adopted.

FIG. 9C is a view illustrating an example of processing up until a result of a pre-trained model that is selected most often is adopted.

FIG. 9D is a view illustrating an example of processing up until a result of a pre-trained model that is selected most often is adopted.

FIG. 9E is a view illustrating an example of processing up until a result of a pre-trained model that is selected most often is adopted.

FIG. 10A is a view illustrating an example of display of object detection results.

FIG. 10B is a view illustrating an example of display of object detection results.

FIG. 11A is a view illustrating an example of object detection results.

FIG. 11B is a view illustrating an example of object detection results.

FIG. 11C is a view illustrating an example of object detection results.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

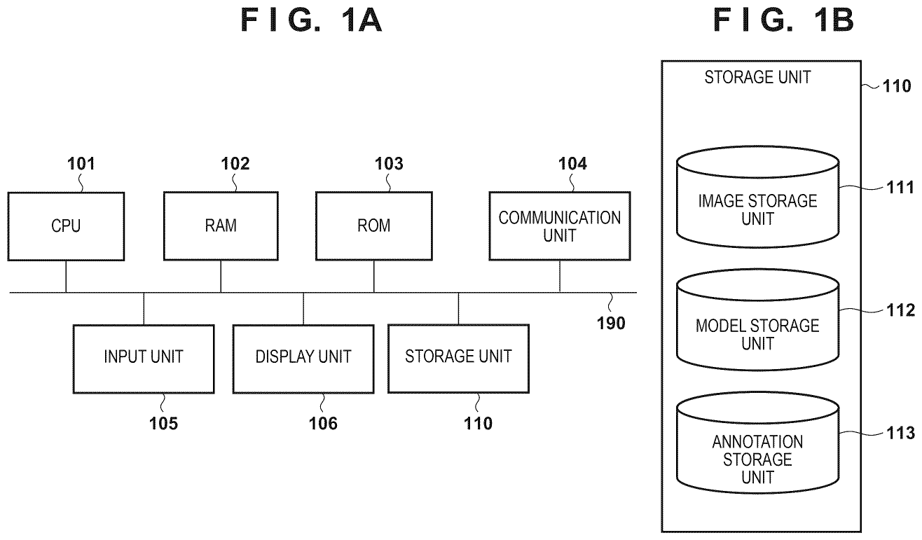

First, an example of a hardware configuration of an information processing apparatus according to the present embodiment will be described with reference to a block diagram of FIG. 1A. A computer apparatus such as a PC, a smart phone, or a tablet terminal can be applied to the information processing apparatus according to the present embodiment.

A CPU 101 executes various processing using computer programs and data stored in a RAM 102. As a result, the CPU 101 controls overall operation of the information processing apparatus and executes or controls various processing to be described as processing performed by the information processing apparatus.

The RAM 102 has an area for storing computer programs and data loaded from a ROM 103 or a storage unit 110, and an area for storing computer programs and data received from an external apparatus by a communication unit 104. Further, the RAM 102 has a work area used when the CPU 101 executes or controls various processing. As described above, the RAM 102 can appropriately provide various areas.

The ROM 103 stores setting data of the information processing apparatus, computer programs and data related to activation of the information processing apparatus, computer programs and data related to basic operation of the information processing apparatus, and the like.

The communication unit 104 performs data communication with an external apparatus via a network such as a LAN or the Internet. An input unit 105 is a user interface such as a keyboard, a mouse, and a touch panel, and can input various instructions and information to the information processing apparatus upon operation by the user.

A display unit 106 has a liquid crystal screen and a touch panel screen, and can display a result of processing by the CPU 101, using images, characters, and the like. Note that the display unit 106 may be an image projection apparatus such as a projector that projects images or characters.

The storage unit 110 is a non-volatile large capacity information storage apparatus such as a hard disk drive. In addition to the hard disk drive, a flash memory, various optical media, and the like can be used as the storage unit 110.

The storage unit 110 stores an OS, computer programs and data for causing the CPU 101 to execute or control various processing described as processing performed by the information processing apparatus, and the like.

In the present embodiment, the storage unit 110 includes an image storage unit 111, a model storage unit 112, and an annotation storage unit 113, as illustrated in FIG. 1B. The image storage unit 111 stores an image group that can contain various images such as captured images and CG images. An image stored in the image storage unit 111 is an image that can be a target for adding annotation information in response to a user operation.

The model storage unit 112 stores a plurality of pre-trained models which are models trained in advance so as to output the position and size of an object to be detected in an input image and a likelihood which represents a certainty of the object. Various types of models can be applied to such pre-trained models, and, for example, an object detection model constructed using a Convolutional Neural Network (CNN) can be applied. The model storage unit 112 also stores a threshold value corresponding to each pre-trained model. Note that the pre-trained models are single models or model groups. The annotation storage unit 113 stores annotation information added to an image in response to a user operation.

Each of the image storage unit 111, the model storage unit 112, and the annotation storage unit 113 may be a separate storage apparatus or a separate storage region in the storage unit 110.

Further, the information described above as information stored in the storage unit 110 may be information generated by a user operating the input unit 105, and may be information received from an external apparatus via the communication unit 104.

The CPU 101, the RAM 102, the ROM 103, the communication unit 104, the input unit 105, the display unit 106, and the storage unit 110 are all connected to a system bus 190. Note that the configuration illustrated in FIGS. 1A and 1B is merely one example of a configuration that can be applied to the information processing apparatus according to the present embodiment, and the configuration can be modified/changed as appropriate.

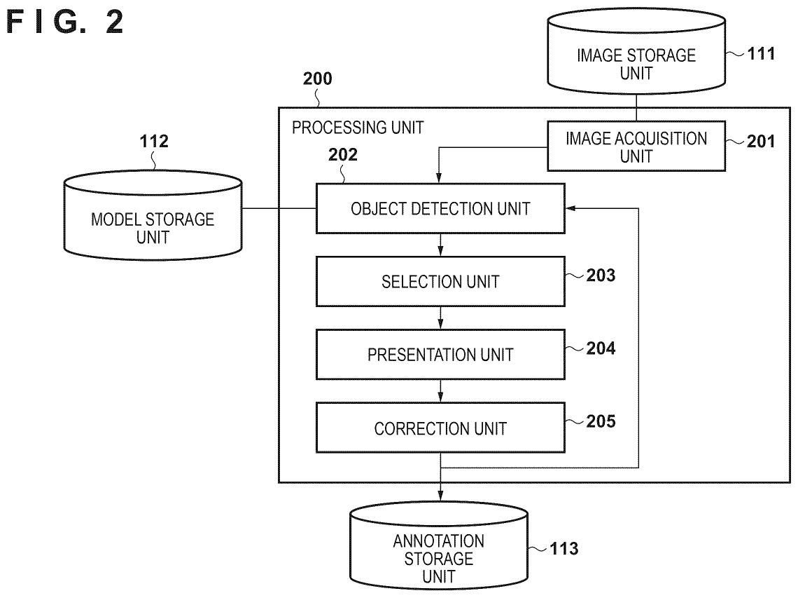

An example of a functional configuration of the information processing apparatus according to the present embodiment is illustrated in a block diagram of FIG. 2. A processing unit 200 includes an image acquisition unit 201, an object detection unit 202, a selection unit 203, a presentation unit 204, and a correction unit 205. In the present embodiment, a case in which each functional unit included in the processing unit 200 is implemented by a computer program will be described. In the following, each of the functional units that the processing unit 200 includes are described as the performer of processing, but in practice, the functions of the functional units are realized by the CPU 101 executing a computer program corresponding to the functional unit. Note that one or more of the functional units included in the processing unit 200 may be implemented by hardware.

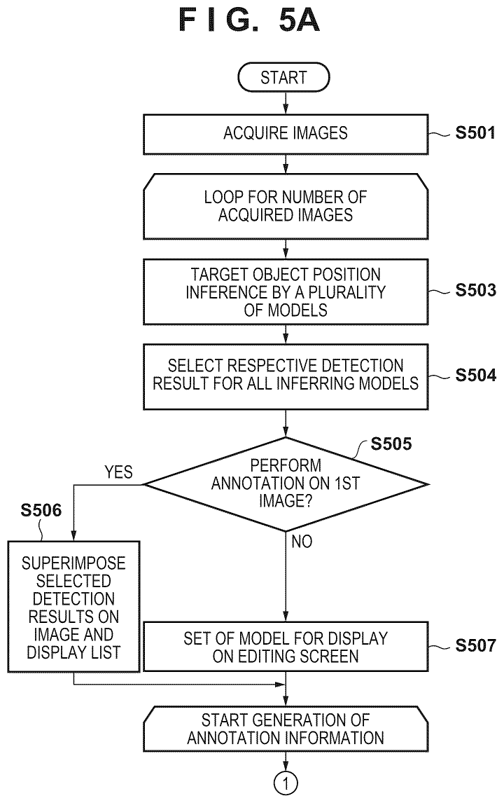

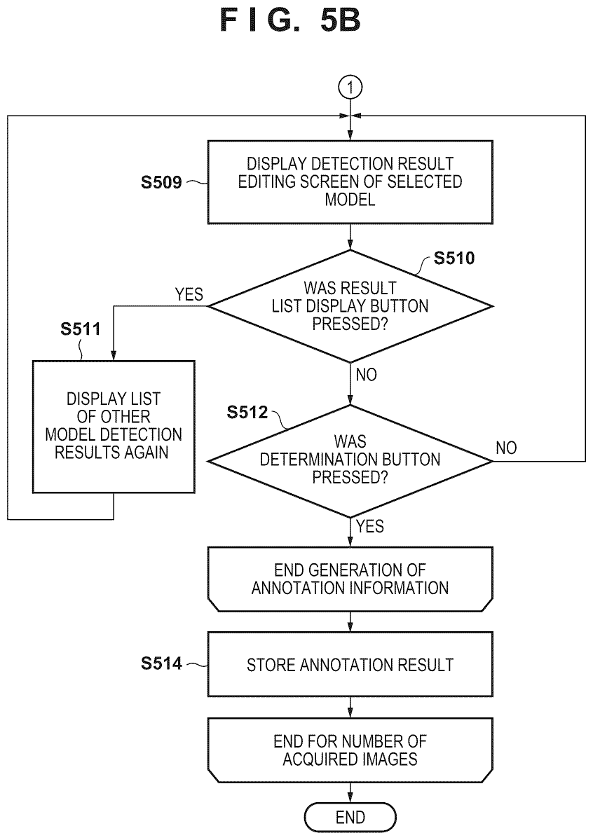

Operation of the information processing apparatus will be described in accordance with the flowchart of FIG. 5A and the flowchart of FIG. 5B. In step S501, the image acquisition unit 201 acquires images to which annotation information is to be added, from an image group stored in the image storage unit 111. The method by which the image acquisition unit 201 acquires the images from the image storage unit 111 is not limited to a specific method.

For example, the image acquisition unit 201 may acquire, from the image storage unit 111, images that the user designates by operating the input unit 105, or may acquire, from the image storage unit 111, images designated in advance.

The subsequent processing of steps S503 to S514 is performed for each of the images acquired in step S501. In step S503, the object detection unit 202 selects one unselected image from the images acquired in step S501 as the selected image. Further, the object detection unit 202 reads a plurality of pre-trained models stored in the model storage unit 112. In the following, for the purpose of concrete explanation, a case in which four pre-trained models trained in advance to detect dogs from an image are stored in the model storage unit 112 will be described. In this case, the object detection unit 202 reads the four pre-trained models from the model storage unit 112. Note that the following description is also similarly applicable to a case where an object of a category other than dog (person, animal, vehicle, or the like) is a detection target.

Next, the object detection unit 202, for each of the four read pre-trained models, acquires (infers) a position (for example, the center position of an image region) and a size (for example, the vertical and horizontal sizes of the image region) of the image region of objects detected as dogs from the selected image and a likelihood (for example, a real value between 0 and 1) representing a likelihood that the object is a dog by inputting the selected image into the pre-trained model and performing the calculation of the pre-trained model. Then, the object detection unit 202, by calculating the following Expression (1) for the likelihood acquired for each of the four pre-trained models, acquires a detection score corresponding to that likelihood.

$$detection score = 255 \times ( likelihood ) \qquad ( 1 )$$

Then, the object detection unit 202 outputs, as object detection results, the position and size of an image region of objects detected as dogs and a detection score corresponding to a likelihood representing the likelihood that the object is a dog, which are acquired for each of the four pre-trained models.

In step S504, the selection unit 203 selects, for each of the four pre-trained models, an object detection result having the largest detection score among the respective object detection results obtained by the pre-trained model as the selection target. If the maximum detection score among the respective object detection results obtained by the pre-trained model is less than the threshold value corresponding to the pre-trained model, the selection unit 203 does not select the object detection result having the maximum detection score as the selection target.

In a case where, for all the pre-trained models, there is no selection target, the selection unit 203 selects the object detection result having the maximum detection score among the object detection results of all the pre-trained models as the selection target, for example.

In step S505, the CPU 101 determines whether processing (annotation) for adding annotation information to the first selected image has not yet been performed. In a case where as the result of the determination, the processing for adding the annotation information has not been performed yet for the first selected image, the processing proceeds to step S506. Meanwhile, the processing for adding the annotation information has already been performed for the first selected image, the processing proceeds to step S507.

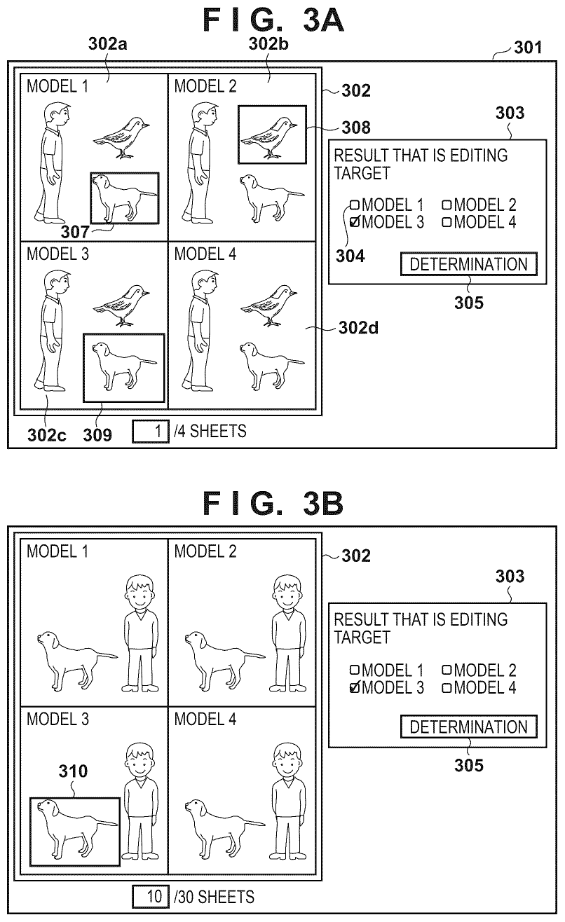

In step S506, the presentation unit 204 causes the display unit 106 to display the object detection results selected as the selection target in step S504. An example of an object detection result display in step S506 is illustrated in FIG. 3A. Hereinafter, unless specifically mentioned, the screen display on the display unit 106 is performed by the presentation unit 204.

A region 302a corresponding to a model 1, a region 302b corresponding to a model 2, a region 302c corresponding to a model 3, and a region 302d corresponding to a model 4 among four pre-trained models (the model 1, the model 2, the model 3, and the model 4 in FIG. 3A) are provided in a display region 302 provided on a display screen 301 of the display unit 106.

The selected image is displayed in the region 302a, and a frame 307 having a “size contained in the result of object detection by the model 1” is displayed at a “position contained in the result of object detection by the model 1” on the selected image.

The selected image is displayed in the region 302b, and a frame 308 having a “size contained in the result of object detection by the model 2” is displayed at a “position contained in the result of object detection by the model 2” on the selected image.

The selected image is displayed in the region 302c, and a frame 309 having a “size contained in the result of object detection by the model 3” is displayed at a “position contained in the result of object detection by the model 3” on the selected image. The selected image is displayed in the region 302d, but since no result of object detection by the model 4 is selected as a selection target, a frame is not displayed therein.

The user confirms the object detection results (the position and size of the frame) by each model displayed on the display screen illustrated in FIG. 3A, and confirms the model of their desired object detection result. Since the frame 307 tightly surrounds a dog (detection was possible at the correct size at the center position of the region where the dog is present), the result of object detection by the model 1 is the desired object detection result. The frame 308 surrounds a bird because the model 2 has misidentified the bird as a dog. The frame 309 surrounds the dog but is excessively larger in size than the dog's size (the center position of the region where the dog is present is correct but the size is slightly larger).

In a region 303, checkboxes 304 corresponding to each of the models 1 to 4 are provided, and the user can operate the input unit 105 to add a checkmark to a checkbox 304 corresponding to a model with the desired object detection result. In the above example, since the model 1 is a model of a desired object detection result, the user operates the input unit 105 to add a checkmark to the checkbox 304 corresponding to the model 1.

When the user operates the input unit 105 to add the checkmark to the checkbox 304 corresponding to the model 1 and then makes an instruction on a determination button 305, the presentation unit 204 sets the model 1 as the “editing screen display model”, and the processing proceeds to step S509.

When only the result of object detection by the model 3 is selected as the selection target, the frames are not displayed for the models 1, 2, and 4, and a frame 310 is displayed for the model 3, as illustrated in FIG. 3B.

In step S507, the presentation unit 204 sets the pre-trained model selected for the operation of adding the annotation information the previous time as the “editing screen display model” without performing the display as in FIG. 3A. Then, the processing proceeds to step S509.

Hereinafter, a case in which the model 1 is set as the editing screen display model will be described, but the following description can be similarly applied even if another model is set as the editing screen display model.

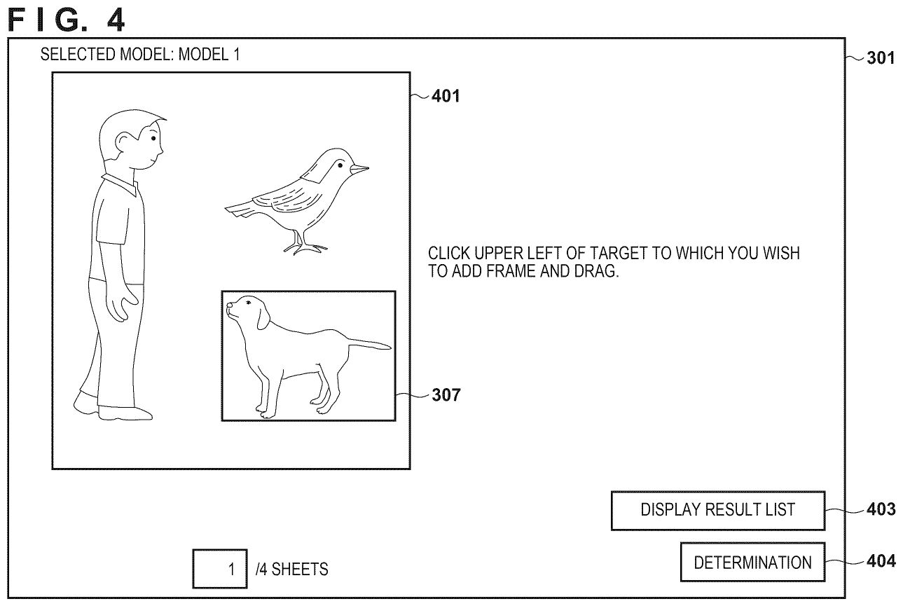

The processing of steps S509 to S512 is repeatedly executed until the annotation information is added to the selected image and stored in the storage unit 110. In step S509, the correction unit 205 causes the display screen 301 to display the screen illustrated in FIG. 4. In FIG. 4, a region 401 displays the result of object detection by the model 1 set as an editing screen display model, that is, the same content as the region 302a. The user can change the position and size of the frame 307 by operating the input unit 105 (that is, change the result of object detection by the model 1).

In step S510, the correction unit 205 determines whether or not a user has made an instruction on a result list display button 403 by operating the input unit 105, for example, for the reason that the user determines that the result of object detection by the model 1 is inappropriate as the standard for the annotation. In a case where the result of this determination is that the user has operated the input unit 105 to make an instruction on the result list display button 403, the processing proceeds to step S511, and in a case where the user has not operated the input unit 105 to make an instruction on the result list display button 403, the processing proceeds to step S512.

In step S511, similarly to in above-described step S506, the presentation unit 204 causes the display unit 106 to display the object detection results selected as the selection targets in step S504. Then, when the user operates the input unit 105 to add a checkmark to the checkbox 304 corresponding to one of the models and then makes an instruction on the determination button 305, the presentation unit 204 sets the model to which the checkmark was added as the “editing screen display model”. Then, the processing proceeds to step S509.

In step S512, the correction unit 205 determines whether or not the user has made an instruction on a determination button 404 by operating the input unit 105. In a case where the result of this determination is that the user has operated the input unit 105 to make an instruction on the determination button 404, the processing proceeds to step S514, and in a case where the user has not operated the input unit 105 to make an instruction on the determination button 404, the processing proceeds to step S509.

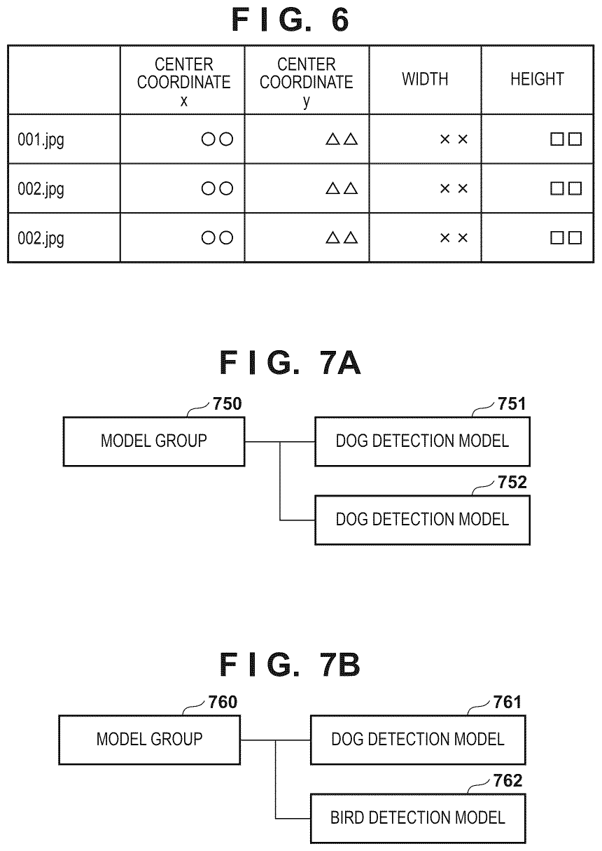

In step S514, the correction unit 205 generates annotation information that may contain information of the selected image and the object detection result according to the editing screen display model, and stores the annotation information in the annotation storage unit 113. FIG. 6 illustrates an example of a configuration of the annotation information.

In the annotation information of FIG. 6, for each selected image file name (001.jpg; 002.jpg; 002.jpg), an x-coordinate (center coordinate x) of the center of the image region of the object detected as a dog from the selected image of the file name, a center y-coordinate (center coordinate y), a width of the image region, and a height of the image region are registered in association with each other.

Note that the foregoing configuration of the annotation information is only one example, and there is no limitation to a specific configuration. In addition, files may be divided and stored for each image, or non-divided collective storage may be performed. In addition, the number of times that the model selected as the “editing screen display model” has been selected may be recorded.

As described above, according to the present embodiment, the object detection result of the maximum detection score (and equal to or greater than a threshold value corresponding to the pre-trained model) among the results of object detection by the pre-trained models is displayed for each pre-trained model, and therefore, it is expected that erroneous detection results will not be displayed.

The output destination of the object detection result is not limited to the display unit 106, and for example, the object detection result may be transmitted to an external apparatus via the communication unit 104 and displayed on a display screen included in the external apparatus.

### <Modification>

In the first embodiment, object detection results of each pre-trained model are acquired by inputting an image into each pre-trained model, but the object detection results of each of groups of pre-trained models may be acquired by inputting the image into each pre-trained model group. Hereinafter, differences from the first embodiment will be described for the present modification.

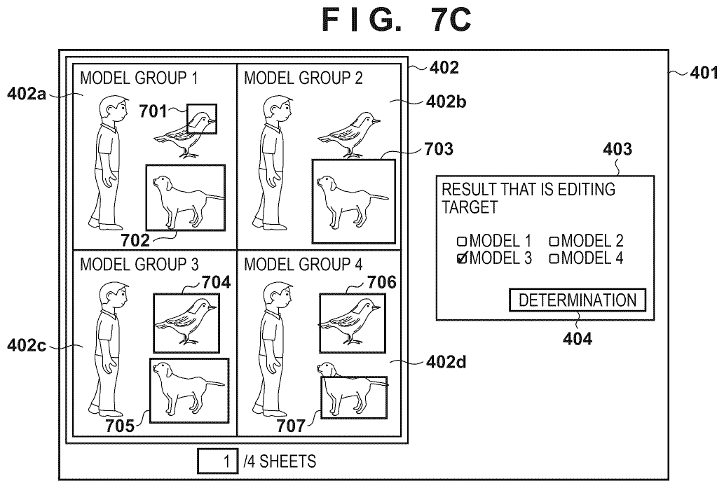

A pre-trained model group may be, for example, a model group 750 containing dog detection models 751 and 752 that detect dogs from images, as illustrated in FIG. 7A. Further, for example, a pre-trained model group may be a model group 760 containing a dog detection model 761 that detects a dog from an image and a bird detection model 762 that detects a bird from an image. That is, a pre-trained model group may be a group of models that detect the same type of object from an image, or may be a group of models that detect different objects from the image, respectively. The number of pre-trained models contained in a pre-trained model group is not limited to a specific number.

For example, assume that four model groups containing a dog detection model and a bird detection model are stored in the model storage unit 112. In such a case, in step S503, the object detection unit 202, for each of the four model groups read out from the model storage unit 112, inputs a selected image into each of the dog detection model and the bird detection model in the model group, and performs a calculation of the dog detection model and the bird detection model. Thus, for each of the four model groups, the object detection unit 202 acquires (infers) “a position and size of image regions of objects detected as a dog from the selected image, a likelihood which represents the likelihood that the object is a dog (dog detection results), a position and size of the image region of objects detected as birds from the selected image”, and a “likelihood which represents the likelihood that the object is a bird” (bird detection results). Then, the object detection unit 202 acquires detection scores from the likelihoods as in the first embodiment.

In step S504, the selection unit 203 selects, for each of the four model groups, the dog detection result having the maximum detection score and the bird detection result having the maximum detection score as selection targets. Similarly to in the first embodiment, if the maximum detection score is less than a threshold value, the selection unit 203 does not select the dog detection result/bird detection result with the maximum detection score as the selection target. In such cases, in step S506, the presentation unit 204 displays the dog detection result and/or the bird detection result for each model group as illustrated in FIG. 7C.

A region 402a corresponding to a model group 1, a region 402b corresponding to a model group 2, a region 402c corresponding to a model group 3, and a region 402d corresponding to a model group 4 among four model groups (the model group 1, the model group 2, the model group 3, and the model group 4 in FIG. 7C) are provided in a display region 402 provided on the display screen 401 of the display unit 106.

The selected image is displayed in the region 402a, and a frame 702 having a “size at which it is contained in a dog detection result by a dog detection model in the model group 1” is displayed at a “position contained in a dog detection result by a dog detection model in the model group 1” on the selected image. In addition, a frame 701 having a “size at which it is contained in the bird detection result by the bird detection model in the model group 1” is displayed at a “position contained in the bird detection result by the bird detection model in the model group 1” on the selected image.

The selected image is displayed in the region 402b, and a frame 703 having a “size at which it is contained in a dog detection result by a dog detection model in the model group 2” is displayed at a “position contained in a dog detection result by a dog detection model in the model group 2” on the selected image. Since the bird detection result by the bird detection model in the model group 2 is not selected as the selection target, the frame is not displayed.

The selected image is displayed in the region 402c, and a frame 705 having a “size at which it is contained in a dog detection result by a dog detection model in the model group 3” is displayed at a “position contained in a dog detection result by a dog detection model in the model group 3” on the selected image. In addition, a frame 704 having a “size at which it is contained in the bird detection result by the bird detection model in the model group 3” is displayed at a “position contained in the bird detection result by the bird detection model in the model group 3” on the selected image.

The selected image is displayed in the region 402d, and a frame 707 having a “size at which it is contained in a dog detection result by a dog detection model in the model group 4” is displayed at a “position contained in a dog detection result by a dog detection model in the model group 4” on the selected image. In addition, a frame 706 having a “size at which it is contained in the bird detection result by the bird detection model in the model group 4” is displayed at a “position contained in the bird detection result by the bird detection model in the model group 4” on the selected image. As described above, in the present modification example, it is possible to deal with an image containing a plurality of objects of the same type and objects of respectively different types.

### Second Embodiment

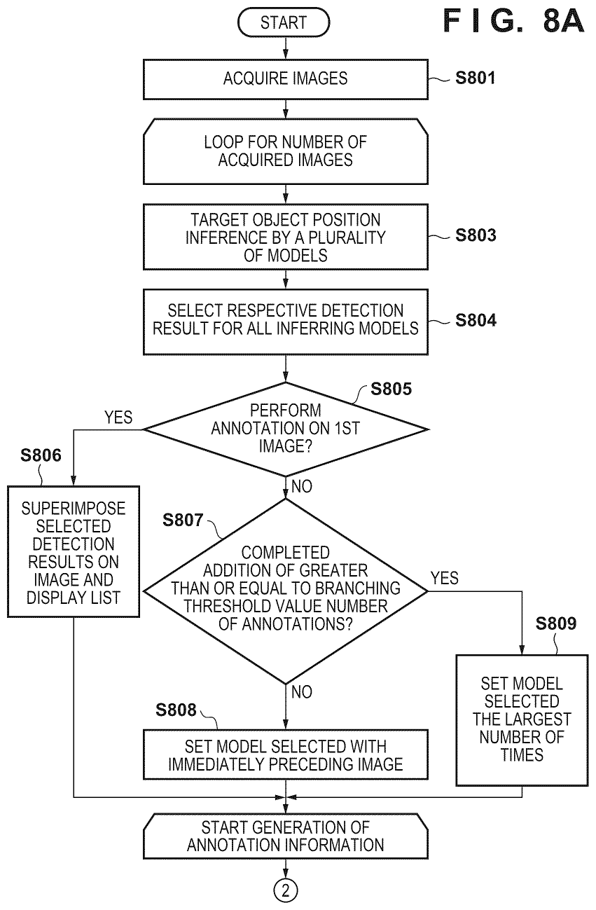

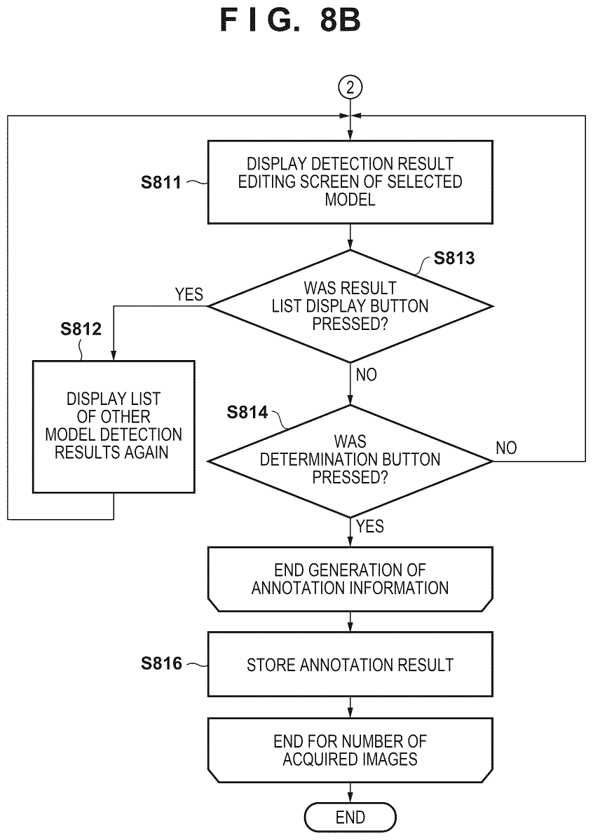

Hereinafter, differences from the first embodiment will be described, and second embodiment is to be considered the same as the first embodiment unless otherwise specifically touched upon below. The operation of the information processing apparatus will be described in accordance with the flowchart of FIG. 8A and the flowchart of FIG. 8B. The processing of steps S801 to S806, S808, and S811 to S816 in FIG. 8A and FIG. 8B is the same as steps S501 to S506, S507, and S509 to S514 in FIG. 5A and FIG. 5B, respectively, and therefore the explanation of steps S801 to S806, S808, and S811 to S816 is omitted.

In step S807, the CPU 101 determines whether or not the number of annotated selected images is equal to or greater than a preset branching threshold value. A branching threshold value may be set by a user operating the input unit 105 in advance, or may be acquired from an external apparatus via the communication unit 104, for example.

In a case where the result of such a determination is that the number of annotated selected images is equal to or greater than the preset branching threshold value, the processing proceeds to step S809. Meanwhile, if the number of annotated selected images is less than the preset branching threshold value, the processing proceeds to step S808.

In step S809, the presentation unit 204 sets the pre-trained model selected the largest number of times in the operation performed to add the annotation information, as the editing screen display model.

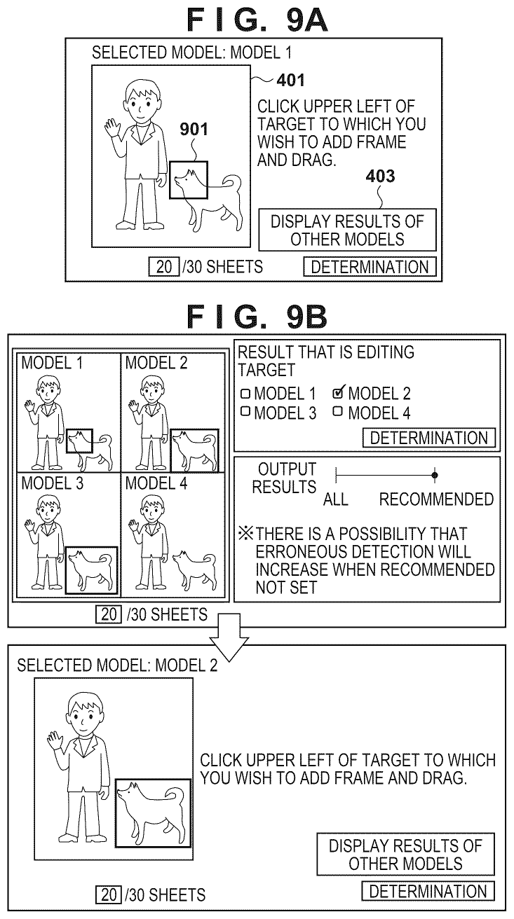

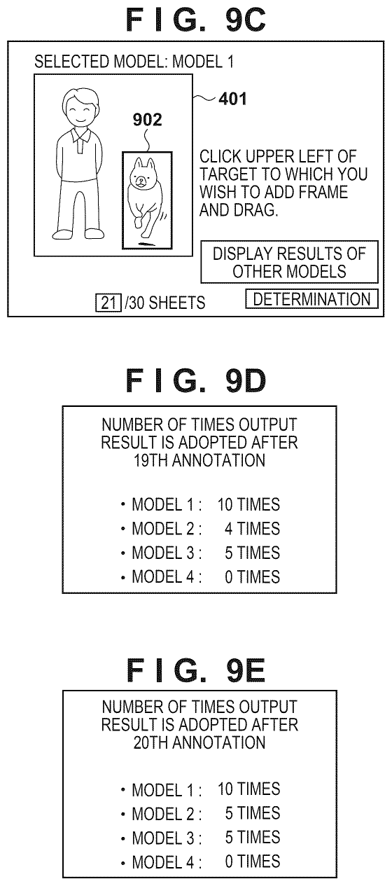

As an example of processing up until the result of the pre-trained model selected the largest number of times is adopted, a detailed description of the content of the processing will be given using FIGS. 9A to 9E, which describe a procedure for, under a condition that there are 30 target images for annotation and the branching threshold value is 20, performing annotation of a 20th image and then transitioning to the annotation of the 21st image.

(i) When annotating the 20th image, since the work for annotation up to the 19th image is completed, the number of annotated images is less than the branching threshold value. Therefore, as illustrated in FIG. 9A, the result of object detection by the pre-trained model selected at the 19th image is displayed in the region 401. In addition, when the annotation information for the 19th image is stored, the number of times that each of the models 1 to 4 is selected (10 times for the model 1, 4 times for the model 2, 5 times for the model 3, and 0 times for the model 4) is also stored, as illustrated in FIG. 9D. Because a frame 901 is displayed around the face of the dog, as illustrated in FIG. 9A, and is not suitable for as the result requested by the user, the user makes an instruction on a button 403.

(ii) When the instruction is made on the button 403 in FIG. 9A, the object detection results of each of the models 1 to 4, as exemplified in FIG. 3A, are displayed, as illustrated in the upper part of FIG. 9B. In FIG. 9B, since annotation information in regards to the twentieth image that the user edited after selecting model 2 is stored, the number of times the model 2 has been selected is updated to five, as illustrated in FIG. 9E.

(iii) Next, processing on the 21st image is performed in the order of steps S803, S804, S805, and then S807. In that case, since images of a number equal to or larger than the branching threshold value have already been annotated, a frame 902 corresponding to a result of object detection by the model 1 which has been selected by the user the largest number of times is displayed as illustrated in FIG. 9C.

When there are a plurality of models which have been selected by the user the largest number of times, the object detection result of the model having the smaller model number is displayed. Specifically, when the model 2 and the model 3 are the models which have been selected by the user the largest number of times, the result of object detection by the model 2 is displayed in the next image. However, which model's object detection result is to be displayed is not limited to the size of the model number as described above, and other methods such as random determination may be used.

In the present embodiment, in step S816, the correction unit 205 generates annotation information and stores the annotation information in the annotation storage unit 113 similarly to in the first embodiment, and also stores, in a memory such as the RAM 102 or the storage unit 110, the number of times the respective models have been selected.

As described above, the present embodiment focuses on being able to determine the model that is able to correctly detect an object that a user annotated according to the number of times that the models are selected, and presents the result of object detection by the model that has been selected the largest number of times. This makes it possible to present an optimal object detection result to the user.

### Third Embodiment

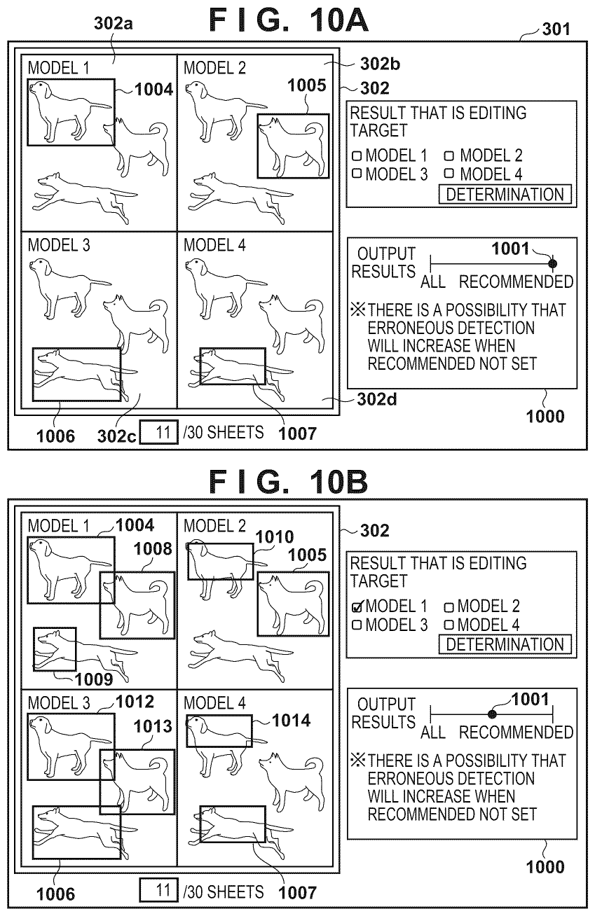

In the present embodiment, operation of the information processing apparatus in a case where four dog detection models are used as the pre-trained model will be described. In the present embodiment, the display unit 106 is caused to display a display screen exemplified in FIG. 10A in step S506 or step S806.

In a region 1000 of the display screen on the display unit 106, an operation unit 1001, which the user can move to the left and right by operating the input unit 105, is provided. Moving the operation unit 1001 to the left sets a larger threshold value, and moving operation unit 1001 to the right sets a smaller threshold value. The initial position of the operation unit 1001 is the rightmost position “RECOMMENDED”. That is, the object detection result with the maximum detection score is set to be displayed for each model.

Therefore, a selected image is displayed in the region 302a, and a frame 1004 corresponding to the object detection result of the model 1 with the largest detection score is displayed on that selected image. The selected image is displayed in the region 302b, and a frame 1005 corresponding to the object detection result of the model 2 with the largest detection score is displayed on that selected image. The selected image is displayed in the region 302c, and a frame 1006 corresponding to the object detection result of the model 3 with the largest detection score is displayed on that selected image. The selected image is displayed in the region 302d, and a frame 1007 corresponding to the object detection result of the model 4 with the largest detection score is displayed on that selected image.

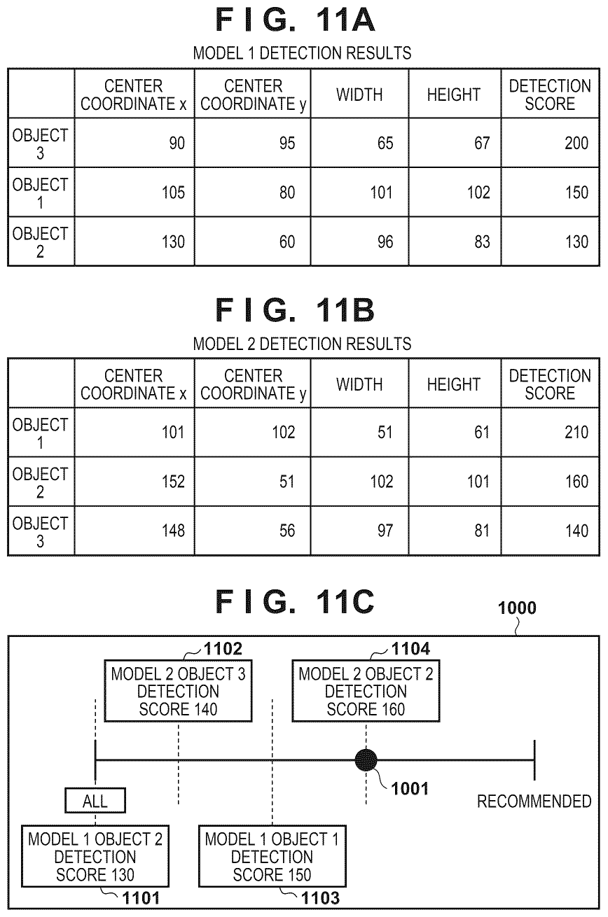

In the following, a case will be described in which results illustrated in FIG. 11A as the results of object detection by the model 1 and results illustrated in FIG. 11B as the results of object detection by the model 2 are obtained.

In order to avoid the possibility that a plurality of object detection results for the same object will be displayed when displaying a plurality of object detection results in the respective models, the following processes are performed in step S504 and step S804.

(i) An IoU (Intersection over Union) indicating the degree of overlap between a region within a frame to be displayed in the display region 302 and a region within each frame already displayed in the display region 302 is calculated using the following Expression (2).

$$IoU = ( A ⋂ B ) / ( A ⋃ B ) \qquad ( 2 )$$

In Equation (2), the IoU is obtained from the union A∪B of a rectangle comprising a region A and a rectangle comprising a region B and the product set A∩B. The IoU is calculated as a value ranging from 0.0 to 1.0.

(ii) When at least one value having a determination value of greater than or equal to 0.5 is contained in each IoU obtained for the frame to be displayed in the display region 302, the object detection result corresponding to the frame is deleted, and the frame is not displayed in the display region 302. The determination value is not limited to 0.5, and is not limited to a specific value as long as it is in the range of 0.0 to 1.0. The determination value can be set by the user using the input unit 105, for example.

Thereafter, a method for determining object detection results to be display targets in accordance with the position of the operation unit 1001 will be described using FIGS. 11A to 11C as an example. Taking the model 1 and the model 2 as an example, among the detection scores (200, 150, 130) of the model 1 and the detection scores (210, 160, 140) of the model 2, the maximum value (210) and the minimum value (130) are assigned to the position of the right end and the position of the left end of the operation unit 1001, respectively, and the other detection scores are assigned to corresponding positions in the range over which the operation unit 1001 moves, as illustrated in FIG. 11C.

A position 1104 is assigned a detection score “160” for an object 2 of the model 2, and a position 1103 is assigned a detection score “150” for an object 1 of the model 1. A position 1102 is assigned a detection score “140” for an object 3 of the model 2, and a position 1101 is assigned a detection score “130” for the object 2 of the model 1.

Therefore, when the user operates the input unit 105 to move the operation unit 1001 to the position 1104, a frame representing an object detection result corresponding to the object 2 of the model 2 is additionally displayed. Also, when the user operates the input unit 105 to move the operation unit 1001 to the position 1103, a frame representing an object detection result corresponding to the object 1 of the model 1 is additionally displayed.

Further, when the user operates the input unit 105 to move the operation unit 1001 to the left end position “all”, as illustrated in FIG. 10B, frames 1008 to 1010 and 1012 to 1014 corresponding to all held object detection results are additionally displayed. Note that the method of additionally displaying a frame using the operation unit 1001 is not limited to a particular method.

The user selects the pre-trained model for which the object detection results for performing the annotation are displayed from the display of FIG. 10B, and the results of the selected pre-trained model are displayed.

As described above, in the present embodiment, configuration is taken to, when a plurality of objects of the same category as the object that the user wishes to detect appear, enable the detection results of the pre-trained models to be displayed for all the appearing objects. In the description of the present embodiment, an example in which a plurality of objects of the same category appear is employed, but a plurality of detection results can be displayed according to adjustment of a threshold value even in a case where a single object appears. Thus, more efficient annotation can be expected to be realized.

Numerical values, processing timings, processing order, the performer of the processing, configuration/method of acquisition/transmission destination/transmission source/storage location of data (information), and the like used in the above-described embodiments and modifications are given as examples for the purpose of a concrete explanation, and there is no intention of limitation to such examples.

In addition, some or all of the above-described embodiments and modifications may be used in combination as appropriate. In addition, some or all of the above-described embodiments and modifications may be used selectively.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-109751, filed Jul. 8, 2024, which is hereby incorporated by reference herein in its entirety.

What is claimed is:

1. An information processing apparatus, comprising:
an acquisition unit configured to, for each of pre-trained models, acquire results of object detection from an image performed by the pre-trained model;
a selection unit configured to, for each of the pre-trained models, select a result to be outputted out of the results of object detection from the image performed by the pre-trained model; and
an output unit configured to output the result selected by the selection unit for each pre-trained model.

2. The information processing apparatus according to claim 1, wherein the acquisition unit, for each pre-trained model, acquires a position and a size of an object detected by the pre-trained model from the image, and a score that is based on a likelihood calculated by the pre-trained model for the object.

3. The information processing apparatus according to claim 2, wherein the selection unit, for each pre-trained model, selects a result having a largest score out of the results of the object detection from the image performed by the pre-trained model.

4. The information processing apparatus according to claim 2, wherein the selection unit, for each pre-trained model, selects the results having a score corresponding to a threshold value set in response to a user operation out of the results of the object detection from the image performed by the pre-trained model.

5. The information processing apparatus according to claim 1, wherein the output unit outputs results of object detection by the pre-trained model selected the previous time in response to a user operation.

6. The information processing apparatus according to claim 1, wherein the output unit
causes the result selected by the selection unit for a pre-trained model selected in response to a user operation to be displayed, and generates, as annotation information, information containing a result of correcting the displayed result in response to a user operation.

7. The information processing apparatus according to claim 1, wherein the output unit outputs a result of object detection by the pre-trained model selected the largest number of times in response to a user operation.

8. The information processing apparatus according to claim 1, wherein
the acquisition unit, for each of pre-trained model groups, acquires results of object detection of each pre-trained model contained in the pre-trained model group, and
the selection unit, for each of pre-trained model groups, selects a result to be outputted from out of results of object detection of each pre-trained model contained in the pre-trained model group.

9. An information processing method performed by an information processing apparatus, the method comprising:
for each of pre-trained models, acquiring results of object detection from an image performed by the pre-trained model;
for each of the pre-trained models, selecting a result to be outputted out of the results of object detection from the image performed by the pre-trained model; and
outputting the selected result for each pre-trained model.

10. A non-transitory computer-readable storage medium storing a computer program for causing a computer to function as:
an acquisition unit configured to, for each of pre-trained models, acquire results of object detection from an image performed by the pre-trained model;
a selection unit configured to, for each of the pre-trained models, select a result to be outputted out of the results of object detection from the image performed by the pre-trained model; and
an output unit configured to output the result selected by the selection unit for each pre-trained model.
